(19) United States
(12) Patent Application Publication
(10) Pub. No.: US 2006/0051055 A1
(43) Pub. Date: Mar. 9, 2006

(54) Content remote watching system, server apparatus for content remote watching, recording/reproducing apparatus for content remote watching, content remote watching method, and computer program product

(75) Inventor: Kenichi Ohkawa, Tokyo (JP)

Correspondence Address: NIXON & VANDERHYE, PC, 901 NORTH GLEBE ROAD, 11TH FLOOR, ARLINGTON, VA, 22203, US

(73) Assignee: Pioneer Corporation, Tokyo (JP)

(21) Appl. No.: 11/220,904

(22) Filed: Sep. 8, 2005

(30) Foreign Application Priority Data
Sep. 9, 2004 (JP) 2004-262785

(51) Int. Cl. H04N 5/76; H04N 5/781

(52) U.S. Cl. 386/46; 386/125

(57) ABSTRACT

In a content remote watching system, a PVR (Personal Video Recorder) owned by a user at home, a server operated or administrated by a carrier, and a mobile phone carried by the user are accommodated in a network. In this system, the user can access a website operated or administrated on the server, and request the reproduction of the content recorded on the PVR from the My HP only for the user. The PVR which is requested to reproduce transmits data for streaming-reproducing the content, to the mobile phone, in accordance with an instruction from the server. In the mobile phone, the data is reproduced and is watched by the user.

### BACKGROUND OF THE INVENTION

1. Field of the Invention

The present invention relates to a content remote watching system, a server apparatus for content remote watching, a recording/reproducing apparatus for content remote watching, a content remote watching method, and a computer program product, which are to watch content recorded on a recording medium, such as a DVD and a HD (Hard Disk).

2. Description of the Related Art

As this type of system, there is a content providing system (hereinafter, referred to as a “related art”), disclosed in Japanese Patent Application Laid Open NO. 2003-339041.

The related art is provided with a server and a terminal apparatus. The server is provided with: a recording device for recording a show or program; and a controlling device which allows communication with the terminal apparatus through an electronic network. If the recording of a show is reserved from the terminal apparatus to the server, the server apparatus starts the recording of the show at a certain time point. Moreover, this server manages shows, which are recorded for each user of the terminal apparatus.

Therefore, it is considered that a user can access the server through the electronic network in desired timing and watch the show recorded on the server.

According to the related art, it is possible to watch a recorded show almost anywhere, however, the show which can be recorded by the server is mainly a TV show. Therefore, watchable content is limited, and it is difficult to say from a user's standpoint that it is worth making a contract with such a content providing system. In view of such a problem, it is possible to prepare content to reflect the preference of each user, to some extent, on the server's side. However, it is merely the content prepared on the server's side, and it is not a fundamental solution.

On the other hand, there is also suggested a technology of directly communicating with a recording apparatus or the like which a user owns at home, through the terminal, and watching the content which the user himself has recorded, at an arbitrary place. In this case, for example, if a recording medium is commutative, it is also possible to provide content which is not merely limited to a TV show. In this case, however, it is hardly possible to reproduce the content with keeping quality, depending on the communication situation between the terminal and the recording apparatus. Moreover, an interface preferable for a user does not intervene between the recording apparatus and the terminal, and to put it briefly, it is not easy to intuitively understand what is now recorded on the recording apparatus. Alternatively, in accessing the recording apparatus, if a process which relatively needs time, such as a reading process, is sequentially performed in the recording apparatus, it is impossible to desire comfortable operationality.

In other words, the related art, or the known technology has such a technical problem that it is extremely difficult for a user to comfortably watch the content which matches his preference, anytime and anywhere.

### SUMMARY OF THE INVENTION

It is therefore an object of the present invention to provide: a content remote watching system, a server apparatus for content remote watching, a recording/reproducing apparatus for content remote watching, a content remote watching method, and a computer program product, which allow a user to comfortably watch the content which matches his preference at a distance place.

The above object of the present invention can be achieved by a content remote watching system accommodated in a network, the system including: (i) a recording/reproducing apparatus capable of recording and reproducing content; (ii) a communication terminal owned by a user of the recording/reproducing apparatus and having portability; and (iii) a server apparatus, the recording/reproducing apparatus provided with: (i) a recording device for recording the content onto a recording medium; (ii) a first reproducing device for reproducing the recorded content; (iii) a content information generating device for generating content information which indicates recording content of the recording medium; and (iv) a first communicating device for transmitting the generated content information through the network to the server apparatus, the server apparatus provided with: (i) a visual information generating device for generating visual information which includes a list of the recorded content and which is associated with the user, on the basis of the transmitted content information; and (ii) a second communicating device for transmitting the generated visual information through the network to the communication terminal, the communication terminal provided with: (i) a displaying device for displaying the transmitted visual information; (ii) an inputting device capable of inputting information for designating content to be reproduced from the list, on the displayed visual information; (iii) a first control information generating device for generating first control information, which is associated with the information inputted through the inputting device and which is to control the server apparatus; and (iv) a third communicating device for transmitting the generated first control information through the network to the server apparatus, the server apparatus further provided with a second control information generating device for generating second control information to control the recording/reproducing apparatus in accordance with the transmitted first control information, the second communicating device further transmitting the generated second control information through the network to the recording/reproducing apparatus, the first reproducing device further generating information for reproduction to reproduce the designated content in accordance with the transmitted second control information, the first communicating device further transmitting the generated information for reproduction through the network to the communication terminal, the communication terminal further provided with a second reproducing device for reproducing the designated content on the basis of the transmitted information for reproduction, the displaying device further displaying the content reproduced by the second reproducing device.

In the present invention, the “network” indicates a wired or wireless communication network, such as the Internet, a LAN (Local Area Network), and a WAN (Wide Area Network). Moreover, it includes a phone line, an ADSL (Asymmetric Digital Subscriber Line), an optical cable line, an access point, a base station, and the like, to realize the wired or wireless communication network.

In the present invention, the “content” indicates all or part of various broadcast programs, such as terrestrial broadcasting, satellite broadcasting, and cable TV broadcasting, and video images recorded on a recording medium or video images with audio, such as private video filmed by the user on his own and video software sold on the market.

In the present invention, the “recording/reproducing apparatus” indicates an apparatus capable of recording and reproducing the content. For example, it indicates a PVR (Personal Video Recorder) which the user owns at home. As the PVR, there is an apparatus capable of recording the content as digital data onto a recording medium and capable of reproducing it, such as a DVD recording/reproducing apparatus and a HDD recording/reproducing apparatus. In this case, the “recording medium” of the present invention indicates an optical information recording medium or a magneto optical recording medium, such as a DVD and a HD. Alternatively, the recording/reproducing apparatus may be a kind of digital video camera capable of recording video, which is filmed by each user, onto the recording medium.

Moreover, the recording/reproducing apparatus of the present invention is provided with: the recording device; and the first reproducing device. The “recording device” herein indicates a device for recording the above-mentioned content; however, it does not only indicate a device for directly writing the data onto the recording medium, such as an optical pickup, but also is defined including a control unit for controlling the optical pickup, or including a data processing unit. Alternatively, the recording device may be unified with the recording medium, such as a HDD.

Moreover, the “first reproducing device” of the present invention indicates a device for reproducing the content. However, as the same concept as in the recording device, the “reproduction” does not only indicate reading the proper information (data) from the recording medium, but also is defined including a device for processing the information (data) to a format or size, which is proper to be displayed on some displaying device for displaying the content in the end.

In the present invention, the “server apparatus” indicates various computer systems, such as a general-purpose computer, a personal computer (PC), and a work station. Moreover, the server apparatus of the present invention may be a server apparatus operated or administrated by a particular company or carrier under the Internet environment, or may be a server apparatus administrated in a limited particular area, such as a IAN.

In the present invention, the “communication terminal” indicates a mobile (or portable) phone, a PDA (Personal Digital Assistance), and a communicable apparatus having portability similar to the above equipment. Incidentally, “having portability” indicates that the user can carry it or transport it on a daily basis in a common sense. For example, it may be a lap-top type personal computer or a sub note type computer.

According to the content remote watching system of the present invention, upon operation thereof, the content information which indicates the recording content of the recording medium is generated by the content information generating device, and transmitted to the server apparatus through the communicating device, in the recording/reproducing apparatus.

The “content information” herein is information which indicates the recording content of the recording medium, but may be arbitrary in the aspect thereof as long as it is not against the spirit. The “recording content” indicated by the content information here may be related to recording of the content in a wide sense, e.g., the content already recorded (i.e., the recorded content itself or the content to be recorded, or may be related to a recording reservation of a broadcast program. For example, the content information may be information including only the name of the content recorded on the recording medium, or may be information including a part of the recorded content. Moreover, the content information may be information which is normally owned by the recording/reproducing apparatus. For example, in the environment that the recording/reproducing apparatus is connected to a TV or the like at home, it is easy to display the list of the content recorded on the recording medium on a TV screen. In that case, the information for displaying the list may be diverted to be the content information.

In the server apparatus, the visual information is generated on the basis of the content information. Here, the “visual information” of the present invention indicates information which is visual and which is generated for each user of the recording/reproducing apparatus (i.e. the user of the communication terminal), and indicates a homepage or the like on a website on the Internet, for example. In this case, the visual information which is associated with the user indicates a homepage for each user, developed on the website, for example. Moreover, the homepage for each user is not limited in the aspect thereof, as long as assigned to each user; however, it may be a homepage accessible through authentication, such as long-in; namely, a homepage concealed from others. Incidentally, in this specification, the “visual information” includes data related to the visual information. Therefore, “to transmit the visual information” represents to transmit HTML data or the like, for example, and “to display the visual information” indicates to display a homepage or the like on a proper screen.

Incidentally, the visual information of the present invention includes at least the list of the content recorded on the recording medium. The “list” herein is not only text data sorted in accordance with some rule, but also may have an aspect of a thumbnail format in which a part of the content is visually displayed, for example. Namely, in the present invention, the “list” includes the whole information which is generated in accordance with some rule so as to judge what is currently recorded on the recording medium. Therefore, it may be the content information itself transmitted from the recording reproducing apparatus.

The generated visual information is transmitted by the second communicating device to the communication terminal. In the communication terminal, the transmitted visual information is displayed on the displaying device.

The “displaying device” in the communication terminal herein may include a display panel with a relatively high space-saving feature or compact feature, such as a liquid crystal display panel, and may include a processing unit for making the display panel display the transmitted information for display, or the like. For example, if the visual information is a website (homepage) as mentioned above, data in a format of HTML (Hyper Text Markup Language) for displaying the website is downloaded and displayed by the displaying device.

The user can input the information through the inputting device on the visual information. The “inputting device” herein can be arbitrary in the aspect thereof, as long as capable of inputting information for designating content to be reproduced from the list, which is included in the visual information. For example, it can adopt the formats of various information input equipment, such as a keyboard, mouse, touch pad, scroll button, soft key button, operational dial, and touch panel device.

Incidentally, the “information for designating content to be reproduced from the list” may be a content name, identification number, or genre to which the content belongs, or the like. If one item in the list can be directly selected on the visual information, it may be information for indicating the selection itself.

If the content is designated through the inputting device, the first control information is generated, which is associated with the information inputted through the inputting device and which is to control the server apparatus. The format of the first control information is not questioned as long as the first control information can control the server apparatus. If the visual information is a homepage on the Internet, when some option is selected on the homepage, as occasion demands, such information may be automatically generated with being linked by the selection. The generated first control information is transmitted by the third communicating device to the server apparatus.

Incidentally, the first control information is associated with the information inputted through the inputting device. If it is the above-mentioned information for designating the content to be reproduced, the “information associated with the information inputted” herein is control information for giving an instruction to reproduce it. If there are other services or functions developed on the visual information and each of them is selected, it may be control information corresponding to each.

In the server apparatus, the second control information for controlling the recording/reproducing apparatus in accordance with the first control information is generated and transmitted to the recording/reproducing apparatus. In the recording/reproducing apparatus, the first reproducing device generates the information for reproduction to reproduce the designated content on the basis of the second control information and transmits it to the communication terminal.

Then, in the communication terminal, the second reproducing device reproduces the content designated on the basis of the information for reproduction. The reproduced content is displayed on the displaying device.

As described above, according to the content remote watching system of the present invention, what records the content is the recording/reproducing apparatus owned by the user himself, so that the content to be recorded reflects the user's preference. In addition, the content to be recorded is not limited to a broadcast program, and may be content filmed or edited by the user himself. Moreover, for example, it may be content which is rented. In other words, there are the relatively high degree of freedom in the options of contents which the user can watch.

Moreover, when the user reproduces the content from the recording/reproducing apparatus, it is unnecessary to directly access the recording/reproducing apparatus, and it is possible to access the server on the network, and transmit the visual information generated for each user, and preferably a reproduction instruction from a homepage, to the recording/reproducing apparatus. As described above, since the server apparatus as a so-called agent intervenes therebetween, it is possible to watch the content anytime, which is recorded by the recording/reproducing apparatus owned by the user himself, without considering elements which take away from comfortableness, such as complicated and unclear operationality and an uncomfortable waiting time, on the user's side. Therefore, it is possible to comfortably watch the content which matches the user's preference at a distant place.

In one aspect of the content remote watching system of the present invention, the recording/reproducing apparatus is further provided with the recording medium.

According to this aspect, the recording/reproducing apparatus is provided with the recording medium, so that it is possible to generate the content information, relatively easily.

In another aspect of the content remote watching system of the present invention, the server apparatus is further provided with a storing device for storing at least one of the transmitted content information and the generated visual information in association with the user.

According to this aspect, at least one of the content information and the visual information is stored by the storing device in the server apparatus, so that it is possible to provide comfortable operationality for the user. For example, if the content information is stored, it is possible to generate the visual information, relatively quickly. Moreover, if the visual information is stored, it is easy to enrich the content of the visual information. Incidentally, in this case, the storage capacity of the storing device assigned to each user may be arbitrarily determined on the server apparatus's side. However, as the assigned capacity increases, the content of the visual information can be expanded more, so that it is possible to provide a more comfortable service for the user.

In another aspect of the content remote watching system of the present invention, the visual information generating device generates the visual information so as to include at least one portion of the recorded content.

According to this aspect, the visual information is generated to include at least one portion of the recorded content, so that convenience improves when the user designates the content to be watched. Incidentally, at least one portion of the content is to indicate the substance of the content to the user. For example, it may be a video image in the introduction of the content or a highlight video image. Moreover, if such video images or picture images related to at least one portion of the content are included, the data size and quality thereof may be determined, depending on the capacity of the server apparatus assigned to the user.

In another aspect of the content remote watching system of the present invention, the server apparatus is further provided with a first authenticating device for performing authentication to allow display of the visual information with respect to the communication terminal, and the second communicating device transmits the visual information to the communication terminal with respect to which the display is allowed.

According to this aspect, the visual information is generated only for the communication terminal authenticated by the first authenticating device. Through such authentication, it is possible to conceal the visual information generated for each user, from others, relatively easily. Moreover, if the content is a kind of public content, such as a broadcast program, then, basically, it is not preferable that a third person watches the content which is recorded by one user. From that view point, this aspect is advantageous. Incidentally, the “first authenticating device” may be arbitrarily set in the aspect thereof, as long as capable of protecting each of contents or privacy of users, regardless of its effect. For example, if the visual information is a website and a homepage on the Internet, the first authenticating device may be a device for making the displaying device of the communication terminal display a log-in screen which is only for authentication, and judging whether or not a person who is trying to access is the user allowed to access through the input of identification information, such as a log-in name and a password.

In another aspect of the content remote watching system of the present invention, the recording/reproducing apparatus is provided with a second authenticating device for performing authentication to allow reproduction of the designated content with respect to the communication terminal, and the first communicating device transmits the information for reproduction, to the communication terminal with respect to which the reproduction is allowed.

According to this aspect, the information for reproduction related to the designated content is transmitted only to the communication terminal authenticated by the second authenticating device, so that security related to the content reproduction improves more.

Incidentally, the authentication in this aspect is performed between the recording/reproducing apparatus and the communication terminal. It indicates that the user holds the ID number of the recording/reproducing apparatus in advance and transmits it to the recording/reproducing apparatus, or the like. The recording/reproducing apparatus is owned by the user, and it is possible to authenticate the user to be a proper user (the user allowed to watch the content) on the recording/reproducing apparatus's side, by transmitting the ID number of the recording/reproducing apparatus. Moreover, in this case, the recording/reproducing apparatus may hold the ID number of the communication terminal in advance, or each of the both may hold the ID number of the other. Incidentally, the aspect of the second authenticating device is not limited to this as long as not departing from the above-mentioned point.

In another aspect of the content remote watching system of the present invention, at least one of the recording/reproducing apparatus and the server apparatus is further provided with an encrypting device for encrypting the information for reproduction, at least one of the communication terminal and the server apparatus is further provided with a decoding device for decoding the encrypted information for reproduction, the first communicating device transmits the encrypted information for reproduction, and the second reproducing device reproduces the designated content on the basis of the decoded information for reproduction.

According to this aspect, at least one of the recording/reproducing apparatus and the server apparatus is provided with the encrypting device for encrypting the information for reproduction. Moreover, at least one of the communication terminal and the server apparatus is provided with the decoding device (or decrypting device) for decoding (or decrypting) the encrypted information for reproduction. Thus, it is possible to fully secure the confidentiality of the content designated by the user.

Here, the “encryption” and the “decoding” in this aspect may be arbitrary in the aspects thereof, as long as capable of concealing the information for reproduction from others, regardless of the degree of the effect. For example, various encryption modes which are known, such as a CBC encryption mode, may be used.

Moreover, the encrypting device is provided for at least one of the recording/reproducing apparatus and the server apparatus. This means that the encrypting device may be provided for either one, or that the encrypting device may be provided for the both. Provided for the both indicates an aspect in which if the encrypting device uses an encryption key to encrypt the information for reproduction, the encryption key is generated on the server apparatus's side and received on the recording/reproducing apparatus, to thereby perform the encryption. As described above, in generating the encryption key on the server apparatus's side, it is possible to reduce a processing load on the recording/reproducing apparatus's side. Needless to say, the encryption key may be generated on the recording/reproducing apparatus's side. In that case, the encrypting device may include a CPU (Central Processing Unit) or the like, which can subsequently read and execute an encryption program stored in advance in a ROM (Read Only Memory) or the like. Incidentally, the decoding device can adopt various aspects in response to the aspects of the encrypting device.

In another aspect of the content remote watching system of the present invention, the visual information generating device further generates the visual information so as to include recording-content-changing-information for promoting performance of a recording content changing process related to a change in the recording content of the recording medium, the inputting device can further input information for giving an instruction to perform the recording content changing process on the visual information, and the recording/reproducing apparatus is further provided with a recording-content-changing device for performing the recording content changing process in accordance with the transmitted second control information.

According to this aspect, the visual information includes the recording-content-changing-information, and the user can give an instruction to perform the recording content changing process through the inputting device, as occasion demands. The “recording content changing process” herein is not limited in the content or substance thereof at all, as long as related to a change in the recording content of the recording medium. For example, it indicates a process of deleting arbitrary content from the recording medium. Alternatively, it indicates performing the recording reservation of a broadcast program with respect to the recording/reproducing apparatus.

If an instruction to perform the recording content changing process is given, the second control information, which is generated on the server apparatus, is transmitted including the instruction to perform the recording content changing process. Then, the recording content changing process is performed by the recording-content-changing device on the recording/reproducing apparatus. For example, in the case of the delete of the content mentioned above, the designated content is deleted by the recording-content-changing device. Alternatively, in the case of the recording reservation of a broadcast program, the relevant program is recorded at a designated time point. Incidentally, with respect to the recording reservation, the visual information may be generated such that the user can select program guide information for performing the reservation. Even a process indirectly related to a change in the recording content of the recording medium (which is the display of the program guide herein), as described above, is also in a range of the recording content changing process. Incidentally, this type of program guide may be uploaded into the visual information by the server apparatus obtaining it from a website on the network, as occasion demands. If the visual information is provided as a homepage on the Internet, it may be set to jump to a linked page by selecting a button on a screen, such as “display of a program guide”.

According to this aspect, without taking away from operationality and comfortableness, it is possible to provide a highly value-added service for the user. Moreover, such a recording content changing process or recording-changing-information can be easily expanded, as needed, on the server apparatus's side. In performing such expansion, the comfortableness of the user increases more.

In another aspect of the content remote watching system of the present invention, the visual information generating device further generates the visual information so as to include information for promoting a change in content of the visual information, the inputting device further can input information for giving an instruction to change the visual information on the visual information, and the visual information generating device changes the content of the visual information in accordance with the transmitted first control information.

According to this aspect, the visual information includes the information for promoting a change in the visual information, and the user can give an instruction to change the visual information through the inputting device, as occasion demands. “To change the visual information” herein has various aspects, such as to change the name of each content in the list and to change the design of the visual information displayed on the display device, for example. The visual information generating device changes the visual information, as occasion demands, in accordance with the first control information transmitted from the communication terminal.

If such a change in the visual information can be performed on the user's side, the user can easily construct the visual information to match his sensibility. This can improves the user's comfortableness more.

In another aspect of the content remote watching system of the present invention, the server apparatus is further provided with a third control information generating device for generating third control information for giving an instruction to transmit the content information, with respect to said recording/reproducing apparatus, the second communicating device further transmits the third control information in each predetermined timing, to the recording/reproducing apparatus, the content information generating device generates the content information in accordance with the third control information, and the first communicating device transmits the content information every time the content information is generated.

According to this aspect, the server apparatus generates the third control information and transmits it in predetermined timing to the recording/reproducing apparatus through the second communicating device. The content information is generated on the recording/reproducing apparatus's side in accordance with the third control information, and is transmitted to the server apparatus. The predetermined timing herein is set in advance on the server apparatus's side, and it is set as an interval of about several hours, for example. Such timing, however, may be set on the user's side by that the server apparatus transmits information related to the setting of the timing to the communication terminal as one portion of the above-mentioned information for promoting a change in the content of the visual information.

In another aspect of the content remote watching system of the present invention, the content information generating device generates the content information if the recording content of the recording medium is changed, and the first communicating device transmits the content information every time the content information is generated.

According to this aspect, the content information generating device can generate the content information if the recording content of the recording medium is changed, and the content information can be transmitted through the first communicating device. Thus, it is possible to automatically obtain the newest content information on the server apparatus's side if there is a change in the recording content of the recording medium. Therefore, the convenience of the visual information provided by the server apparatus improves more.

In another aspect of the content remote watching system of the present invention, the first reproducing device generates the information for reproduction, in accordance with a reproduction condition of the designated content in at least one of the second reproducing device and the displaying device.

According to this aspect, the first reproducing device generates the information for reproduction, in accordance with a reproduction condition in at least one of the second reproducing device and the displaying device. Thus, it is possible to reproduce the content, comfortably, on the communication terminal.

The “reproduction condition in at least one of the second reproducing device and the displaying device” includes all the possibilities which can be a condition in reproducing the designated content, such as the data processing capacity of the second reproducing device, the size of the display area of the displaying device, and the resolution (pixels) of the displaying device. In this case, for example, the first reproducing device may generate the information for reproduction with a lower image quality of the content, as occasion demands, depending on the data processing capacity of the second reproducing device.

In another aspect of the content remote watching system of the present invention, the recording/reproducing apparatus is further provided with a compressing device for compressing the designated content, and the first reproducing device generates the information for reproduction related to the compressed content.

According to this aspect, the content is compressed by the compressing device, and the first reproducing device generates the information for reproduction related to the compressed content. Thus, it is possible to remarkably reduce a display processing load on the communication terminal. Incidentally, such content compression is arbitrary in the aspect thereof, however, it may be performed on the basis of a known data compression standard, such as MPEG 2, for example.

Incidentally, the compressing device may perform the compression in recording the content. In other words, the compressed content may be recorded on the recording medium. Even in this case, the “designated content” is compressed, and it is in a range of this aspect.

<Server Apparatus for Content Remote Watching>

The above object of the present invention can be also achieved by a server apparatus for content remote watching, capable of communicating with a recording/reproducing apparatus and a communication terminal through a network, the recording/reproducing apparatus provided with: (i) a recording device for recording content onto a recording medium; (ii) an apparatus's side reproducing device for generating information for reproduction to reproduce designated content, in accordance with server-side control information, which is transmitted through the network, for giving an instruction to reproduce the designated content, out of contents recorded on the recording medium; (iii) a content information generating device for generating content information which indicates recording content of the recording medium; and (iv) an apparatus's side communicating device for transmitting the generated content information and the information for reproduction through the network to the server apparatus, the communication terminal, owned by a user of the recording/reproducing apparatus and having portability, provided with: (i) a displaying device for displaying visual information which is transmitted through the network, which includes a list of the recorded content, and which is associated with the user; (ii) an inputting device capable of inputting information for designating content to be reproduced from the list included in the displayed visual information, as the designated content; (iii) a terminal-side control information generating device for generating terminal-side control information, which is associated with the information inputted through the inputting device; (iv) a terminal-side communicating device for transmitting the generated terminal-side control information through the network; and (v) a terminal-side reproducing device for reproducing the designated content on the basis of the transmitted information for reproduction, the server apparatus provided with: a visual information generating device for generating the visual information on the basis of the transmitted content information; a server-side communicating device for transmitting the generated visual information through the network to the communication terminal; and a server-side control information generating device for generating the server-side control information in accordance with the transmitted terminal-side control information, the server-side communicating device transmitting the generated server-side control information through the network to the recording/reproducing apparatus.

According to the server apparatus for content remote watching of the present invention, upon the operation thereof, it functions as the server apparatus in each aspect of the above-mentioned content remote watching system of the present invention. Therefore, it is possible to comfortably watch the content which matches the user's preference at a distant place.

<Recording/Reproducing Apparatus for Content Remote Watching>

The above object of the present invention can be also achieved by a recording/reproducing apparatus for content remote watching, capable of communicating with a server apparatus and a communication terminal through a network, the server apparatus provided with: (i) a visual information generating device for generating visual information which includes a list of content recorded on a recording medium, on the basis of content information which is transmitted through the network and which indicates recording content of the recording medium; (ii) a server-side communicating device for transmitting server-side control information for giving an instruction to reproduce the generated visual information and designated content, through the network; and (iii) a server-side control information generating device for generating the server-side control information in accordance with terminal-side control information, which is transmitted through the network, for requesting reproduction of the designated content, the communication terminal having portability, provided with: (i) a displaying device for displaying the transmitted visual information; (ii) an inputting device capable of inputting information for designating content to be reproduced from the list included in the displayed visual information, as the designated content; (iii) a terminal-side control information generating device for generating the terminal-side control information; (iv) a terminal-side communicating device for transmitting the generated terminal-side control information through the network to the server apparatus; and (v) a terminal-side reproducing device for reproducing the designated content on the basis of information for reproduction transmitted through the network, the recording/reproducing apparatus provided with: a recording device for recording the content onto the recording medium; an apparatus's side reproducing device for reproducing the recorded content; a content information generating device for generating the content information; and an apparatus's side communicating device for transmitting the generated content information through the network to the server apparatus, the apparatus's side reproducing device generating the information for reproduction to reproduce the designated content, in accordance with the transmitted server-side control information, the apparatus's side communicating device further transmitting the generated information for reproduction through the network, to the communication terminal.

According to the recording/reproducing apparatus for content remote watching of the present invention, upon the operation thereof, it functions as the recording/reproducing apparatus in each aspect of the above-mentioned content remote watching system of the present invention. Therefore, it is possible to comfortably watch the content which matches the user's preference at a distant place.

<Content Remote Watching Method>

The above object of the present invention can be also achieved by a content remote watching method performed in a content remote watching system accommodated in a network, the system including: (i) a recording/reproducing apparatus capable of recording and reproducing content; (ii) a communication terminal owned by a user of the recording/reproducing apparatus and having portability; and (iii) a server apparatus, the method provided with: in the recording/reproducing apparatus, (i) a recording process of recording the content onto a recording medium; (ii) a first reproducing process of reproducing the recorded content; (iii) a content information generating process of generating content information which indicates recording content of the recording medium; and (iv) a first transmitting process of transmitting the generated content information through the network to the server apparatus, in the server apparatus, (i) a visual information generating process of generating visual information which includes a list of the recorded content and which is associated with the user, on the basis of the transmitted content information; and (ii) a second transmitting process of transmitting the generated visual information through the network to the communication terminal, in the communication terminal, (i) a displaying process of displaying the transmitted visual information; (ii) an inputting process of inputting information for designating content to be reproduced from the list, on the displayed visual information; (iii) a first control information generating process of generating first control information, which is associated with the information inputted in the inputting process and which is to control the server apparatus; and (iv) a third transmitting process of transmitting the generated first control information through the network to the server apparatus, in the server apparatus, the method further provided with a second control information generating process of generating second control information to control the recording/reproducing apparatus in accordance with the transmitted first control information, in the server apparatus, the method further provided with a fourth transmitting process of transmitting the generated second control information through the network to the recording/reproducing apparatus, the first reproducing process further generating information for reproduction to reproduce the designated content in accordance with the transmitted second control information, in the recording/reproducing apparatus, the method further provided with a fifth transmitting process of transmitting the generated information for reproduction through the network to the communication terminal, in the communication terminal, the method further provided with a second reproducing process of reproducing the designated content on the basis of the transmitted information for reproduction, the displaying processing further displaying the content reproduced by the second reproducing process.

According to the content remote watching method of the present invention, upon the operation thereof, each device is realized in the aspects of the above-mentioned content remote watching system of the present invention. Therefore, it is possible to comfortably watch the content which matches the user's preference at a distant place.

Incidentally, in the present invention, the server apparatus may be administrated or operated by some company. In this case, moreover, the visual information may be provided as a form of website (homepage) on the Internet. Moreover, if the communication terminal is a mobile phone, the company may be the same or can be regarded to be the same as a carrier of hte mobile phone.

In one aspect of the content remote watching method of the present invention, the method is further provided with: an encrypting process of encrypting the information for reproduction, in at least one of the recording/reproducing apparatus and the server apparatus; and a decoding process of decoding the encrypted information for reproduction, in at least one of the communication terminal and the server apparatus, the fifth transmitting process transmits the encrypted information for reproduction, and the second reproducing process reproduces the designated content on the basis of the decoded information for reproduction.

According to this aspect, the confidentiality of the content improves by the encrypting process and the decoding process. Thus, the possibility that the copyright of the content or the like is infringed is remarkably reduced, which is preferable.

In another aspect of the content remote watching method of the present invention, it is further provided with a charging process of charging to the user in accordance with a usage situation of the server apparatus.

According to this aspect, the user is changed by the changing process in accordance with the usage situation of the server apparatus. “In accordance with the usage situation of the server apparatus” herein indicates that an appropriate usage fee may be charged in the beginning in a form of blanket contract, with some company which administrates the server apparatus, that it may be charged at each time of content reproduction, or that it may be charged in accordance with the addition of some service (e.g. expansion of the visual information, etc.). Incidentally, if the company is a telecommunications company (a communication carrier) and the communication terminal is a mobile phone, the charging may be made in a form included in a telephone bill.

According to this aspect, it can increase the possibility that the present invention may be spread as a form of new business.

<First Computer Program Product>

The above object of the present invention can be also achieved by a first computer program product in a computer-readable medium for tangibly embodying a program of instructions executable by a computer system to make the computer system function as at least one portion of the above-mentioned server apparatus.

According to the first computer program product of the present invention, the server apparatus in the content remote watching system of the present invention can be embodied relatively readily, by loading the computer program product from a recording medium for storing the computer program product, such as a ROM (Read Only Memory), a CD-ROM (Compact Disc-Read Only Memory), a DVD-ROM (DVD Read Only Memory), a hard disk or the like, into the computer system, or by downloading the computer program product, which may be a carrier wave, into the computer system via a communication device.

Incidentally, in response to various aspects of the server apparatus in the content remote watching system of the present invention, the first computer program product of the present invention can also adopt various aspects.

<Second Computer Program Product>

The above object of the present invention can be also achieved by a second computer program product in a computer-readable medium for tangibly embodying a program of instructions executable by a computer system to make the computer system function as at least one portion of the above-mentioned communication terminal.

According to the second computer program product of the present invention, the communication terminal in the content remote watching system of the present invention can be embodied relatively readily, by loading the computer program product from a recording medium for storing the computer program product, such as a ROM (Read Only Memory), a CD-ROM (Compact Disc-Read Only Memory), a DVD-ROM (DVD Read Only Memory), a hard disk or the like, into the computer system, or by downloading the computer program product, which may be a carrier wave, into the computer system via a communication device.

Incidentally, in response to various aspects of the communication terminal in the content remote watching system of the present invention, the second computer program product of the present invention can also adopt various aspects.

<Third Computer Program Product>

The above object of the present invention can be also achieved by a third computer program product in a computer-readable medium for tangibly embodying a program of instructions executable by a computer system to make the computer system function as at least one portion of the above-mentioned recording/reproducing apparatus.

According to the third computer program product of the present invention, the recording/reproducing apparatus in the content remote watching system of the present invention can be embodied relatively readily, by loading the computer program product from a recording medium for storing the computer program product, such as a ROM (Read Only Memory), a CD-ROM (Compact Disc-Read Only Memory), a DVD-ROM (DVD Read Only Memory), a hard disk or the like, into the computer system, or by downloading the computer program product, which may be a carrier wave, into the computer system via a communication device.

Incidentally, in response to various aspects of the recording/reproducing apparatus in the content remote watching system of the present invention, the third computer program product of the present invention can also adopt various aspects.

As discussed above, the content remote watching system of the present invention is provided with the recording/reproducing apparatus, the server, and the communication terminal, so that it is possible to comfortably watch the content which matches the user's preference at a distant place. The server apparatus for content remote watching of the present invention is provided with the visual information generating device, the server-side communicating device, and the server-side control information generating device, so that it is possible to comfortably watch the content which matches the user's preference at a distant place. The recording/reproducing apparatus for content remote watching of the present invention is provided with the recording device, the apparatus-side reproducing device, the content information generating device, and the apparatus-side communicating device, so that it is possible to comfortably watch the content which matches the user's preference at a distant place. In the content remote watching method of the present invention, it is possible to comfortably watch the content which matches the user's preference at a distant place by virtue of each process which realizes the operation of each device in the above-mentioned content remote watching system. The first computer program product of the present invention makes a computer system as at least one portion of the above-mentioned server apparatus, so that it is possible to realize the server apparatus in the above-mentioned content remote watching system of the present invention, relatively easily. The second computer program product of the present invention makes a computer system as at least one portion of the above-mentioned communication terminal, so that it is possible to realize the communication terminal in the above-mentioned content remote watching system of the present invention, relatively easily. The third computer program product of the present invention makes a computer system as at least one portion of the above-mentioned recording/reproducing apparatus, so that it is possible to realize the recording/reproducing apparatus in the above-mentioned content remote watching system of the present invention, relatively easily.

The nature, utility, and further features of this invention will be more clearly apparent from the following detailed description with reference to preferred embodiments of the invention when read in conjunction with the accompanying drawings briefly described below.

### BRIEF DESCRIPTION OF THE DRAWINGS

FIG. 1 is a conceptual view showing a content remote watching system according to an embodiment of the present invention;

FIG. 2 is a block diagram showing a PVR in the system in FIG. 1;

FIG. 3 is a block diagram showing a server in the system in FIG. 1;

FIG. 4 is a block diagram showing a mobile phone in the system in FIG. 1;

FIG. 5 is a timing chart explaining the outline of the operation of the system in FIG. 1;

FIG. 6A to FIG. 6F are schematic diagrams showing screens displayed on the mobile phone, in the outline of the operation in FIG. 5;

FIG. 7 is a flowchart showing a content information transmission process in the PVR;

FIG. 8 is a flowchart showing a content information reception process in the server;

FIG. 9 is a flowchart showing a user interface process in the server;

FIG. 10 is a flowchart showing a content reproduction process in the PVR; and

FIG. 11 is a flowchart showing a process in the mobile phone.

### DETAILED DESCRIPTION OF THE PREFERRED EMBODIMENT

The preferred embodiment of the present invention will be explained with reference to the drawings.

<Structure of Embodiment>

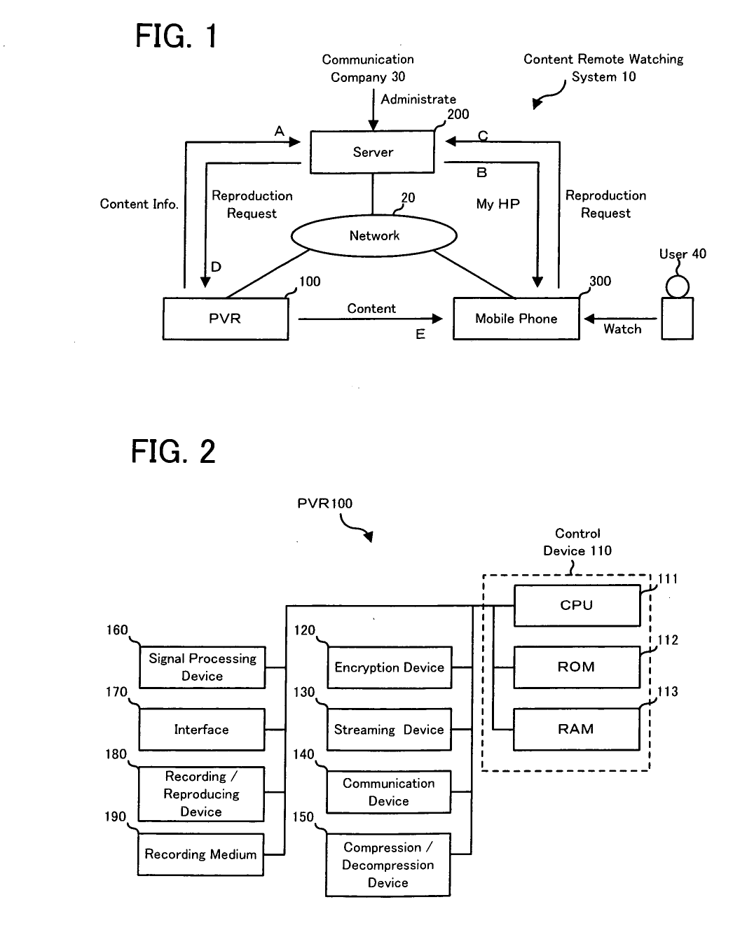

At first, with reference to FIG. 1, the concept of the embodiment of the present invention will be discussed, with the outline of the operation thereof. FIG. 1 is a conceptual view showing a content remote watching system 10.

In the content remote watching system 10 (hereinafter, abbreviated to a “system 10”, as occasion demands), a PVR (Personal Video Recorder) 100, a server 200, and a mobile phone 300 are accommodated in a network 20.

The network 20 is the Internet, or a wired or wireless communication network for accessing the Internet, for example.

The PVR 100 is provided with a HD and a DVD, as a recording medium, and is one example of the “recording/reproducing apparatus” of the present invention, which is constructed to record and reproduce content. Incidentally, the detailed structure of the PVR 100 will be discussed later.

The server 200 is operated or administrated by a communication company or telecommunications carrier 30 (hereinafter referred to as a “company 30”, as occasion demands). The server 200 is one example of the “server apparatus” of the present invention, which is constructed to mutually communicate with the PCR 100 and the mobile phone 300 through the network 20. Incidentally, the detailed structure of the server 200 will be discussed later.

The mobile phone 300 is owned and carried by a user 40, and is one example of the “communication terminal” of the present invention, which is constructed to mutually communicate with the PCR 100 and the server 200 through the network 20. It is assumed that the user 40 has the PVR 100 at home or the like, for example. Incidentally, the detailed structure of the mobile phone 300 will be discussed later.

In such a structure, in the system 10, the PVR 100 firstly records content and transmits the content information, which is the substance information thereof, to the server 200 (arrow A) through the Network 20.

The server 200 generates My Homepage (hereinafter referred to as “My HP”, as occasion demands) which is a website on the network 20 on the basis of the content information, and transmits it to the mobile phone 300 (arrow B). The user 40 visually confirms the My HP, selects content which he or she desires to reproduce, and designates it from the mobile phone 300 to the server 200 (arrow C). The server 200 instructs the PVR 100 to reproduce the designated content (arrow D), and the PVR 100 distributes the content in real time to the mobile phone 300 (arrow E). The distributed content is displayed on the mobile phone 300, and watched by the user 40. In this manner, the system 10 is constructed such that the user 40 can watch the content recorded by using the PVR 100, through the mobile phone 300 at a distant place.

Incidentally, in the system 10, the company 30 is a telecommunications carrier which manages the communication by the mobile phone 300, and makes an individual contract with a user who desires to use the My HP. Therefore, the company 30 can collect a cost related to the communication of the mobile phone 300 (a packet communication charge, a basic charge, or the like), together with the usage charge of the My HP. The user 40 in the embodiment is a user or users who make such a contract, and there is at least one user. The term “user 40” in the explanation below is used to indicate all the users who make the contract, or one of them. The company 30 gives a peculiar log-in name and password to the user 40. By using the log-in name and the password, the user 40 can log in or into (i.e., login to or log on) the My HP.

Incidentally, in the system 10, the company 30 is a telecommunications carrier of the mobile phone 300; however, the company 30 is not limited to the telecommunications carrier. If a company other than the communications carrier administrates the My HP, the company may collect the usage charge aside from the communication fee of the mobile phone 300.

<Detailed Structure of Content Remote Watching System 10>

<Structure of PVR 100>

Next, with reference to FIG. 2, the detailed structure of the PVR 100 will be discussed. FIG. 2 is a block diagram of the PVR 100.

In FIG. 2, the PVR 100 is provided with: a control device 110; an encryption device (or encoder) 120; a streaming device 130; a communication device 140; a compression/decompression (or expansion) device 150; a signal processing device 160; an interface 170; a recording/reproducing device 180; and a recording medium 190.

The control device 110 is provided with: a CPU (Central Processing Unit) 111; a ROM 112; and a RAM (Random Access Memory) 113.

The CPU 111 is a control unit for controlling the operation of the PVR 100. The ROM 112 is a non-volatile storage medium and stores therein an ID number peculiar to the PVR 100. The RAM 113 is a volatile storage medium and functions as a buffer for temporarily storing data generated in the operational procedure of the PVR 100.

The encryption device 120 can perform the encryption process of content under the control of the CPU 111, and can generate an encryption key necessary for the encryption. The encryption device 120 is one example of the “encrypting device” of the present invention.

The streaming device 130 can generate streaming data in transmitting the content to the mobile phone 300.

The communication device 140 is a communication device, referred to as a modem, for example, for helping the PVR 100 communicate with the server 200 and the mobile phone 300 through the network 20.

The compression/decompression (or expansion) device 150 can compress data related to content in recording the content and can supply it to the recording/reproducing device 180. It can also extend (or expand) the compressed data, in reading the content from the recording/reproducing device 180.

The signal processing device 160 is a data processing device for recording the content. It includes a tuner, a separation circuit for a video signal and audio signal, and the like for example.

The interface 170 is an interface of the recording/reproducing device 180 and each constitutional element in the PVR 100. It includes an ATA interface, for example.

The recording/reproducing device 180 can write and read the data related to the content, with respect to the recording medium 190. The recording/reproducing device 180 may include an optical pickup, magnetic head, or the like, which have a structure corresponding to the aspect of the recording medium 190.

The recording medium 190 is an optical information recording medium, such as a DVD, or a magnetic recording medium, such as a HD. Incidentally, the recording medium 190 may be constructed in one body with the recording/reproducing apparatus 180 in advance, or may be constructed in a different body. In the embodiment, it is assumed that various contents are recorded by the operation of the user 40, or by various functions, such as reservation recording, on the recording medium 190.

<Structure of Server 200>

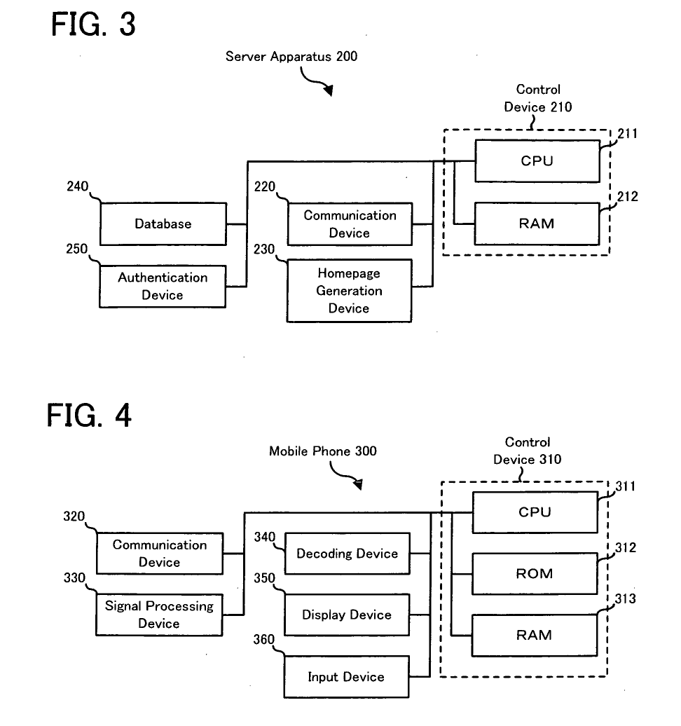

Next, with reference to FIG. 3, the detailed structure of the server 200 will be discussed. FIG. 3 is a block diagram of the server 200.

In FIG. 3, the server 200 is provided with: a control device 210; a communication device 220; a homepage generation device 230; a database 240; and an authentication device 250.

The control device 210 is provided with: a CPU 211; and a RAM 212.

The CPU 211 is a control unit for controlling the operation of the server 200. The RAM 212 is constructed to function as a buffer for temporarily storing data generated in the operational procedure of the server 200.

The communication device 220 is a communication device, referred to as a modem, for example, for helping the server 200 communicate with the PVR 100 and the mobile phone 300 through the network 20.

The homepage generation device 230 can generate a homepage related to “Hello PVR” which is a website administrated by the company 30 on the server 200, and can generate the My HP assigned to each user 40 on the Hello PVR. The homepage generation device 230 is one example of the “visual information generating device” of the present invention.

The database 240 can store therein the My HP, the content information, and the access setting information of the user 40, with respect to each user 40. The database 240 is one example of the “storing device” of the present invention. Incidentally, the access setting information indicates information including the log-in name and password of the user 40, the ID number of the PVR 100, the ID number of the mobile phone 300, or the like.

The authentication device 250 is controlled by the CPU 211, and can perform authentication when the user accesses the My HP. The authentication device 250 is one example of the “first authenticating device” of the present invention.

Next, with reference to FIG. 4, the detailed structure of the mobile phone 300 will be discussed. FIG. 4 is a block diagram of the mobile phone 300.

In FIG. 4, the mobile phone 300 is provided with: a control device 310; a communication device 320; a signal processor 330; a decoding device 340; a display device 350; and an input device 360.

The control device 310 is provided with: a CPU 311; a ROM 312; and a RAM 313.

The CPU 311 is a control unit for controlling the operation of the mobile phone 300. The ROM 312 is a non-volatile storage medium and stores therein an ID number peculiar to the mobile phone 300. The RAM 313 is a volatile storage medium and can function as a buffer for temporarily storing data generated in the operational procedure of the mobile phone 300.

The communication device 320 is a communication device for helping the mobile phone 300 communicate with the PVR 100 and the server 200 through the network 20.

The signal processor 330 is a signal processing unit, which is provided with: an RF (Radio Frequency) processing device for processing a high-frequency signal obtained through the communication device 320; an analog baseband processor for obtaining an audio signal from the RF processed signal; a digital baseband processor for digitalizing an analog signal, and the like (which are all not illustrated).

The decoding device (or decrypting device) 340 can decode (or decrypt) the streaming data of the content encrypted and transmitted from the PVR 100. The decoding device 340 is one example of the “decoding device” of the present invention.

The display device 350 is provided with a liquid crystal display apparatus, for example, and can display a screen related to the My HP, with respect to the user 40. The display device 350 is one example of the “displaying device” of the present invention.

The input device 360 is an input device for inputting various information to the mobile phone 300, and can adopt various aspects, such as a soft key button, an operational dial, and an operational lever. The input device 360 is one example of the “inputting device” of the present invention.

<Operation of Embodiment>

<Basic Operation of Content Remote Watching System 10>

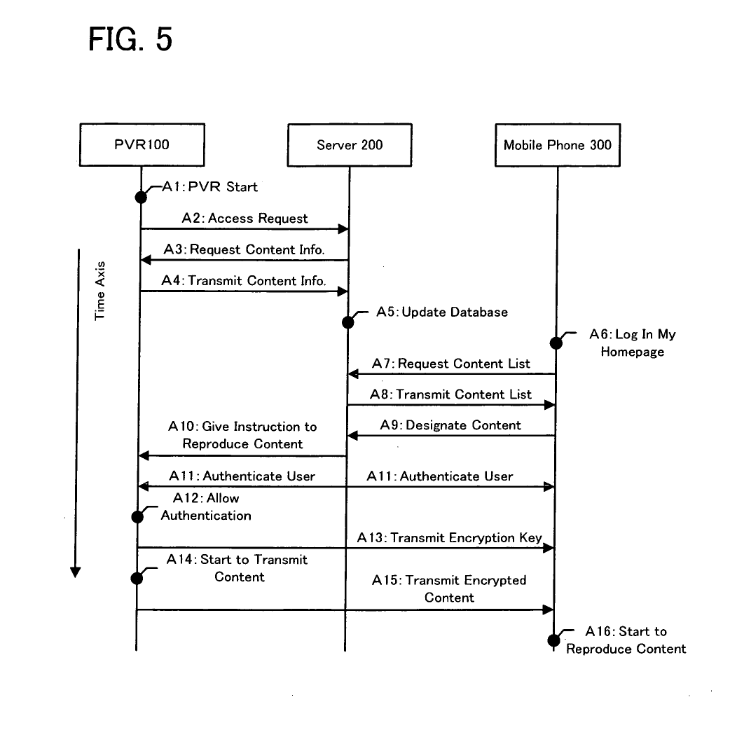

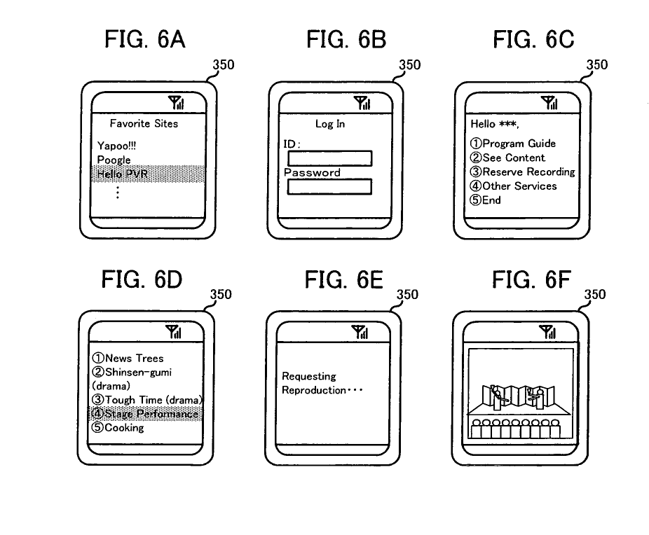

Next, with reference to FIG. 5 and FIG. 6A to FIG. 6F, the basic operation of the system 10 will be discussed. FIG. 5 is a timing chart related to the outline of the operation of the system 10 as a whole. FIG. 6A to FIG. 6F are schematic diagrams showing the screen states of the display device 350 of the mobile phone 300. In FIG. 5, time proceeds from the top to the bottom. Moreover, FIG. 5 shows the outline of the operation, and the detailed operation of each constitutional element will be discussed later.

In FIG. 5, at first, the PVR 100 is started (A1). The PVR 100 may be firstly started by the user 40. If the server 200 is constructed to start the PVR 100, the PVR 100 may be started by the server 200.

If started, the PVR 100 transmits an access request for always-on connection to the server 200 (arrow A2). The server 200 which receives the access request judges whether or not the PVR 100 is an already registered apparatus. If judging that it is a normal or proper apparatus, the server 200 requests the content information (arrow A3). The PVR 100 of which the content information is requested transmits the content information to the server 200 (arrow A4). The server 200 which receives the content information updates the database 240 (A5).

In the meanwhile, it is assumed that the user 40 logs in the My HP (A6).

FIG. 6A and FIG. 6B show this procedure. At first, the user 40 selects which website in the Internet to connect, from a favorite menu, for example. If the “Hello PVR” on the serve 200 administrated by the company 30 is selected (FIG. 6A), a log-in screen only for members is displayed (FIG. 6B). Here, the user 40 inputs the login-name and password given to him, to thereby log in. If the log-in is completed, the My HP is displayed (FIG. 6C).

Incidentally, for example, in FIG. 6A, when the “Hello PVR” is selected, a homepage which is common in users (a main screen) may appear, and each user may call up the log-in screen to the My HP, on the main screen.

Back in FIG. 5, the user 40 requests a content list of the server 200 (arrow A7). In response to the request, the server 200 transmits the content list (arrow A8). The content list is a list of various contents which are recorded by the user 40 on the PVR 100, and it is possible to select the content which the user 40 desires to watch, from them (FIG. 6D). If some content is selected, a content reproduction request is transmitted to the server 200 in response to the selection operation (arrow A9). At this time point, a message for indicating the reproduction requesting is displayed on the display device 350 of the mobile phone 300 (FIG. 6E).

The server 200 transmits an instruction to reproduce the content designated by the user 40 (arrow A10). If receiving the reproduction instruction, the PVR 100 performs a process of authenticating the user 40 (arrow A11). If the authentication is succeeded (A12), an encryption key is transmitted from the PVR 100 to the mobile phone 300 (arrow A13). Then, the content is encrypted by using the encryption key, and the transmission to the mobile phone 300 is started (A14). Then, the encrypted content is sequentially transmitted (arrow A15). At this time point, the content selected by the user 40 is displayed on the display device 350 of the mobile phone 300 (FIG. 6F).

In the system 10, the content is transmitted to the user 40 substantially in the above manner, and watched by the user 40.

<Detailed Operation of Each Constitutional Element>

Next, the detailed operation of each constitutional element will be discussed.

<Content Information Transmission Process from PVR 100>

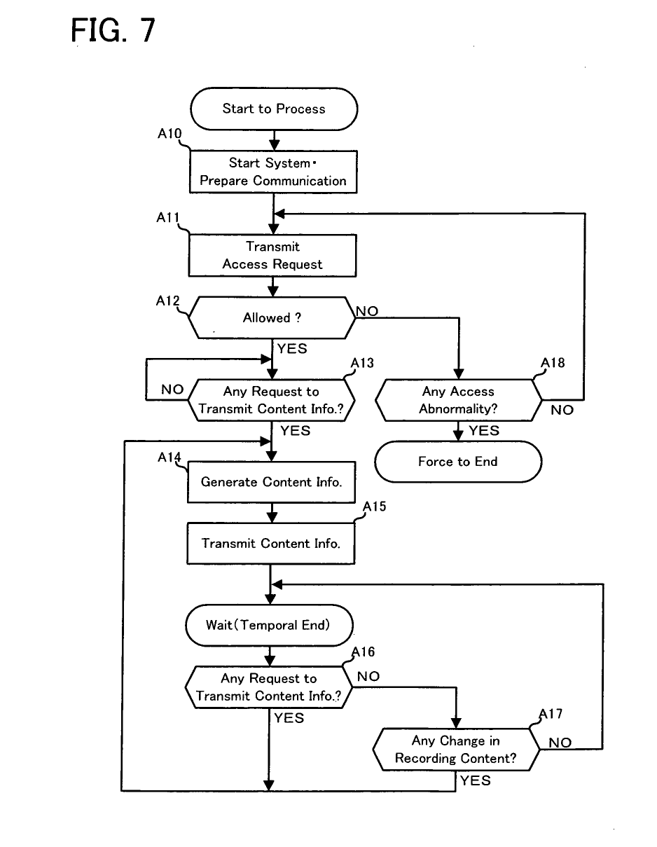

At first, with reference to FIG. 7, the details of the content information from the PVR 100 to the server 200 will be discussed. FIG. 7 is a flowchart showing the content information transmission process.

In FIG. 7, the PVR 100 is started (step A10). This start represents a start from a state in which a power supply is shut down, and it is a generic term of naming power-on by the user 40, power-on by a remote control from the server 200, a start by a timer, such as the reserved recording of content, or the like. Incidentally, as long as the power is on, for example, if the PVR 100 is apparently stopped due to a sleep function for power saving or the like, this is treated as a waiting state, described later.

If the PVR 100 is started, the CPU 111 transmits an access request to the server 200 (step A11). In transmitting the access request, the CPU 111 generates information including the ID number thereof stored in the ROM 112, and transmits it through the communication device 140.

The CPU 111 judges whether or not the access request is allowed (step A12). If the access is allowed, access allowance information is received through the communication device 140, and temporarily stored onto the RAM 113. Incidentally, the data or the like received through the communication device 140 is temporarily stored onto the RAM 113, however, the description related to the RAM 113 will be omitted, as occasion demands, in the explanation below.

If the access is not allowed (the step A12: NO), furthermore, abnormality judgment is performed (step A18). Here, the “abnormality judgment” indicates a process of judging whether or not the PVR 100 can access the server 200 at a current time point. For example, if a communication error occurs due to some troubles in a line (e.g., the network 20), there are many cases where communication may be established after some trials. On the contrary, if it is judged that the transmitted ID number is expired on the server 200 side, the access is impossible. In that case, it is judged to be abnormal, with reference to an access denied notice or the like which is transmitted from the server 200. In the step A12, if it is judged to be abnormal (the step A18: YES), the process is forced to be ended so that a communication line with the server 200 is not established. On the other hand, if it is judged not to be abnormal (the step A18: NO), the CPU 111 returns the process to the step A11, and transmits the access request again. Here, if communication errors continuously occur by the number of times which is set in advance, the judgment in the step A18 is “NO” and the process is forced to be ended.

If the access is allowed by the server 200 (the step A12: YES), the CPU 111 judges whether or not a request for transmitting the content information is received (step A13). If the request for transmitting the content information is not received (the step A13: NO), the operation in the step A13 is loop-processed and continued. On the other hand, if the request for transmitting the content information is received (the step A13: YES), the CPU 111 generates the content information (step A14). Here, the CPU 111 access the recording/reproducing device 180 through the interface 170, and generates the content information as information for transmitting which content is currently recorded on the recording medium 190, to the server 200.

The generated content information is transmitted to the server 200 (step A15). If the transmission of the first content information after the start is ended, the PVR 100 becomes in a waiting state. The waiting status indicates a state in which the communication line with the server 200 is only established. For example, if a set time elapses in this waiting state, the CPU 111 may make the PVR 100 sleep. This sleep state is also one of the waiting state.

In the waiting state, the CPU 111 judges whether or not there is a request for transmitting the content information in constant timing (step A16). If the request for transmitting the content information is received (the step A16: YES), the CPU 111 returns the process to the step A14, generates the content information again, and transmits it to the server 200. On the other hand, if there is no request for transmitting the content information (the step A16: NO), the CPU 111 further judges whether or not there is any change in the recording content of the recording medium 190 (step A17). If there is no change in the recording content (the step A17: NO), the PVR 100 comes back in the waiting state, and the operations in the step A16 and the step S17 are repeated by the CPU 111. On the other hand, if there is a change in the recording content of the recording medium 190 (the step A17: YES), the CPU 111 returns the process to the step A14, generates the content information, and transmits it to the server 200.

<Content Information Reception Process on Server 200>

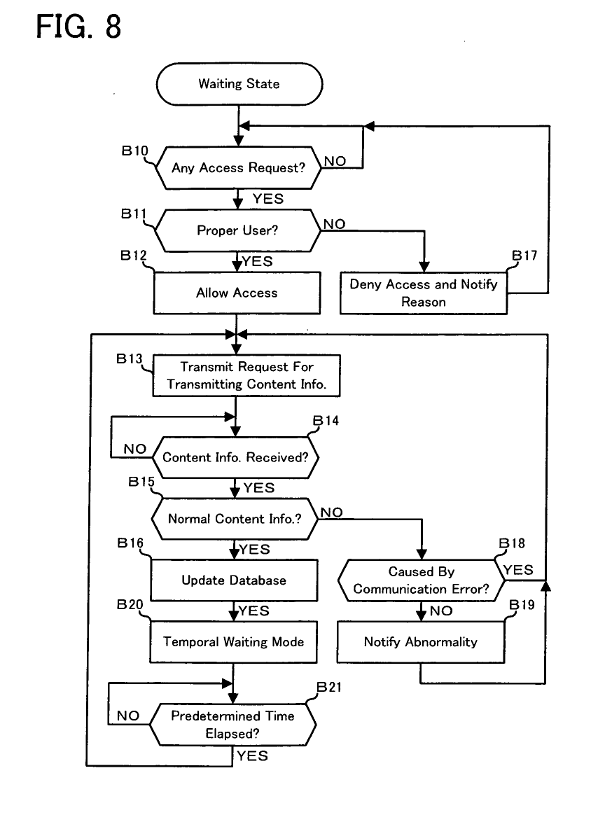

Next, with reference to FIG. 8, the details of the content information reception process on the server 200 will be discussed. FIG. 8 is a flowchart showing the content information reception process.

In FIG. 8, it is assumed that the server apparatus 200 is in the waiting state. The waiting state indicates a state of waiting for some access from the PVR 100 or the mobile phone 300.

In FIG. 8, at first, the CPU 211 judges whether or not there is an access request from the PVR 100 (step B10).

As described above, from the PVR 100, the access request is transmitted at the start of the PVR 100. If the access request is transmitted from the PVR 100 and received by the communication device 220, the access request is temporarily stored onto the RAM 212. If the access request is not stored onto the RAM 212 (the step B10: NO), the step is continued until the access request is stored. Incidentally, not only the access request but also the data or the like which is received through the network 20 are temporarily stored onto the RAM 212; however, the description related to the RAM 212 will be omitted, as occasion demands, in the explanation below.

If the access request is received, the CPU 211 judges whether or not the PVR 100 corresponds to a proper user (step B11). This judgment is performed by judging whether or not there is an ID number included in the access request, in the access setting information of each user 40 stored in the database 240, for example. If there is the relevant ID number, it is judged that the PVR 100 is the one for relevant user 100, and the access request is allowed for the PVR 100 (step B12). If the access is allowed, the access allowance information is transmitted from the communication device 220, and the judgment in the step A12 in FIG. 7 is “YES”.

On the other hand, if there is no relevant ID number in the database 240, or if the registered PVR 100 is expired, it is judged the PVR 100 is the one which is not accessible, and an access denied notice is transmitted to the PVR 100 (step B17), and the server 200 comes back in the waiting state. Incidentally, in this case, the step A18 in FIG. 7 is “YES”.

If the access is allowed, the CPU 211 transmits a request for transmitting the content information, to the PVR 100 (step B13). The CPU 211 synchronizes with a predetermined clock and judges whether or not there is content information transmitted from the PVR 100 (step B14).

If the content information is not received yet (the step B14: NO), the judgment is repeated until the content information is received. If the content information is received (the step B14: YES), it is judged whether or not the received content information is normal content information (step B15).

If the content information is not normal (the step B15: NO), the CPU 211 further judges whether or not that is caused by a communication error (step B18). If the normal content information cannot be obtained because of the communication error (for example, if one portion of the content information is damaged or deleted) (the step B18: YES), the CPU 211 returns the process to the step B13, and requests the transmission of the content information again of the PVR 100. On the other hand, if it is not because of the communication error (the step B18: NO), the CPU 211 judges that the content information is abnormal, and notifies the PVR 100 of an error related to the PVR 100 (step B19), and returns the process to the step B13.

On the other hand, if the received content information is normal content information (the step B15: YES), the CPU 211 updates the data related to the user 40 in the database 240 by controlling the homepage generator 220, as occasion demands, on the basis of the content information (step B16), and controls the server 200 to be in a temporal waiting mode (step B20). In the temporal waiting mode, the CPU 211 judges whether or not a predetermined time elapses (step B21). If the predetermined time does not elapse (the step B21: NO), the CPU 211 repeats the step B21 until the time elapses. If the time elapses (the step B21: YES), the CPU 211 returns the process to the step B13, and transmits a request for transmitting the content information to the PVR 100.

Except this, for example, if the content information is transmitted from the PVR 100, along with a change in the recording content of the recording medium 190, the operation related to the step B14 is performed, as occasion demands, and it is reflected in the content of the database 240. Incidentally, in the operation related to the step B19, if it is judged that the content information is abnormal, such control is performed that the transmission of the content information is not requested again; however, the PVR 100 may be requested to transmit the content information.

<User Interface Process of Server 200>

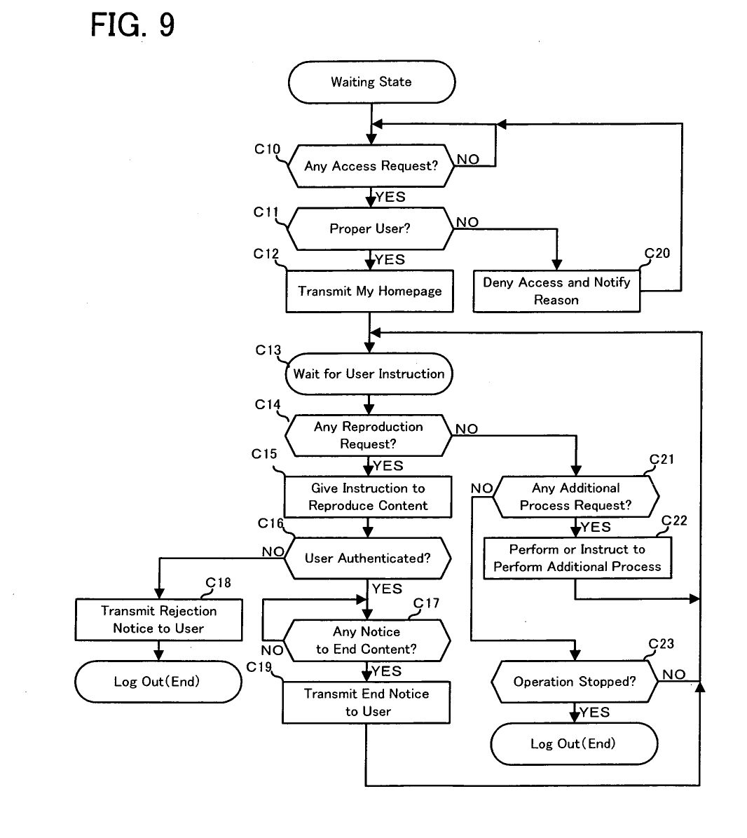

Next, with reference to FIG. 9, the user interface process of the server 200 will be discussed. FIG. 9 is a flowchart showing the user interface process. Incidentally, the user interface process indicates a response process to the access to the My HP by the user 40 or to various operations on the My HP.

In FIG. 9, at first, the CPU 211 judges whether or not there is an access request from the user 40 (step C10). If there is no access request from the user 40 (the step C10: NO), the CPU 211 holds the server 200 in the waiting state. If the access request is received (the step C10: YES), the CPU 211 judges whether or not the user who transmits the access request is a proper user, i.e., the user 40 (step C11).

The judgment in the step C11 is performed through the authentication device 250 controlled by the CPU 211. The access request from the user 40 includes the log-in name and password of the user 40. The authentication device 250 searches for the relevant user from the database 240. As a result of the search, if there is the relevant user, the authentication device 250 determines him to be the relevant user and allows the user who transmits the access request to access (the step C11: YES). On the other hand, if it is not authenticated by the authentication device 250 (the step C11: NO), the CPU 211 transmits an access denied notice including the reason to the mobile phone 300 (step C20) and returns the server 200 to be in the waiting state.

If it is judged to the proper user, the CPU 211 transmits the data related to the My HP of the user 40 stored in the databas2 240, to the mobile phone 300 through the communication device 220 (step C12), and sets the server 200 in a state of waiting for an instruction from the user 40 (step C13). Incidentally, at this time point, the My HP is displayed on the display device 350 of the mobile phone 300. Moreover, the instruction waiting state is a similar state to the waiting state.

In this state, the CPU 211 judges whether or not there is a reproduction request from the user 40 (step C14). If the reproduction request is received (the step C14: YES), the CPU 211 transmits an instruction to reproduce the designated content, to the PVR 100 (step C15).

On the other hand, if the reproduction request is not received, it is judged whether or not an additional process request is received (step C21). Here, the additional process indicates a process which is additional and which is except watching the content, such as deleting the content from the recording medium 190, changing the display content on the My HP, browsing a TV program guide, and making a recording reservation of a show. It is a process including the “recording content changing process” of the present invention, and the process of “changing the content of the visual information”.

If the additional process request is received (the step C21: YES), the CPU 211 performs an additional process selected by the user 40 or transmits an instruction to perform, to the PVR 100 (step C22). For example, in the case of the change in the content of the My HP, the homepage generation device 230 changes corresponding content. In the case of the browse of the TV program guide, the CPU 211 downloads the TV guide from the network 20, and controls the homepage generation device 230 to display it on the My HP. Alternatively, if a position related to the browse of the TV guide is selected by providing a link on the My HP or the like, it may be downloaded and displayed on the My HP which is the linked display data.

If the additional process request is not received (the step C21: NO), the CPU 211 judges whether or not the request from the user 40 is an operation stop request (step C23). If it is the operation stop request (the step C23: YES), the CPU 211 performs a log-out process, and ends the mutual communication between the server 200 and the mobile phone 300 (the user 40). If it is not the operation stop request (the step C23: NO), the CPU 211 judges that there is no request from the user 40 at the current time point and temporarily returns the process to the step C13, and repeats the subsequent operation.

If the PVR 100 is instructed to reproduce the content, the CPU 211 obtains a user authentication result form the PVR 100 through the communication device 220, and judges whether or not the user 40 is authenticated by the PVR 100 (step C16). If the user 40 is not authenticated by the PVR 100 (the step C16: NO), the CPU 211 transmits a rejection notice to the user 40 (step C18), performs the log-out process, and ends the mutual communication between the server 200 and the mobile phone 300.

If the user 40 is authenticated by the PVR 100 (the step C16: YES), the CPU 211 judges whether or not there is a content end notice transmitted from the PVR 100 (step C17). If there is no content end notice (the step C17: NO), the step C17 is repeated until the notice is received. If the content end notice is received (the step C17: YES), the CPU 211 transmits a reproduction end notice to the user 40 (step C19).

<Content Reproduction Process of PVR 100>

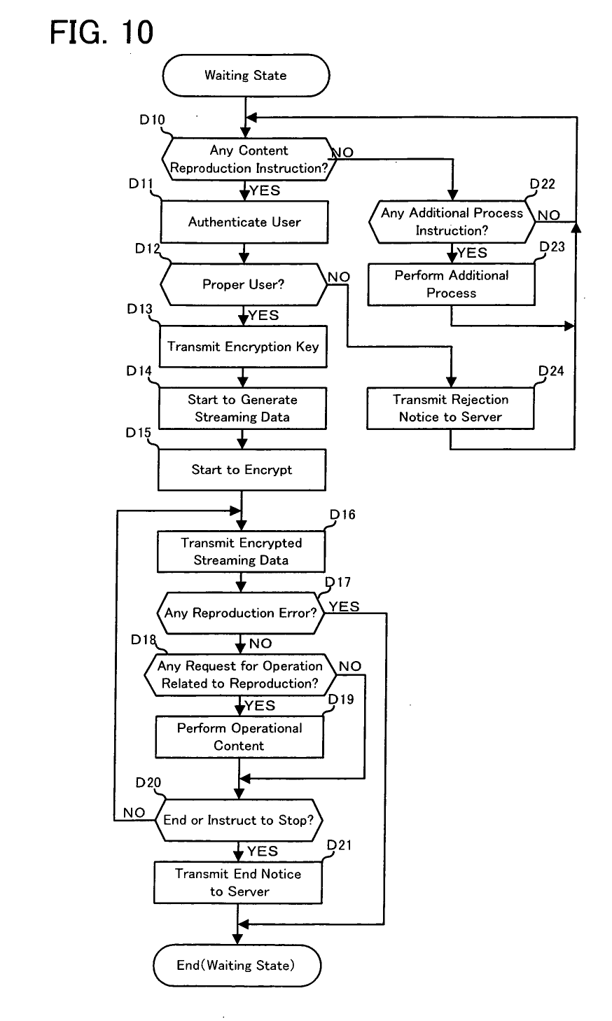

Next, with reference to FIG. 10, the details of the content reproduction process of the PVR 100 will be discussed. FIG. 10 is a flowchart showing the content reproduction process. Incidentally, the content reproduction process explained here indicates a process performed in accordance with an instruction from the user 40 through the mobile phone 300 and the my HP. Moreover, aside from or in parallel with the process, the above-mentioned content information transmission process is performed.

In FIG. 10, at first, it is judged whether or not there is a content reproduction instruction from the server 200 (step D10). If there is no content reproduction instruction (the step D10: NO), the CPU 111 judges whether or not there is an additional process instruction (step D22). If there is no additional process instruction, either (the step D22: NO), the CPU 111 returns the process to the step D10, and judges an instruction from the server 200 again. If there is an additional process instruction (the step D22: YES), the CPU 111 performs the additional process (step D23). Here, the additional process of the PVR 100 indicates deleting the recording content of the recording medium 190, making a recording reservation, and the like, as described above. In the case of the deletion of the recording content, the CPU 111 controls the recording/reproducing apparatus 180 to delete the designated content from the recording medium 190. In the case of the recording reservation, the designated content is obtained through the signal processing device 160 at a designated time point, and recorded onto the recording medium 190 by the recording/reproducing device 180 through the interface 170 and the compression/decompression device 150 or the like. If the additional process is performed, the CPU 111 returns the process to the step D10.

On the other hand, if the instruction from the server 200 is the content reproduction instruction (the step D10: YES), the CPU 111 performs a process of authenticating the user 40 (step D11). Here, since the user 40 has already succeeded the authentication with the server 200 through the log-in process, it is possible to omit the authentication process on the PVR 100. However, from the viewpoint of saving the content, in the embodiment, it is set to perform the authentication of the PVR 100 and the mobile phone 300.

The authentication is performed by that the mobile phone 300 obtains the ID number of the PVR 100 from the database 240 of the server 200 and the ID number of itself from the ROM 312, and by that the mobile phone 300 transmits them to the PVR 100 as authentication information including the both. The PVR 100 which obtains the authentication information examines whether or not the transmitted ID number of the PVR 100 is correct. At the same time, the PVR 100 obtains the ID number of the mobile phone 300 from the server 200 and compares it with the received ID number, to thereby authenticate that the other communication side is the mobile phone 300.

As a result of the authentication, if it is judged not to be the user 40 (the step D12: NO), the CPU 111 transmits a rejection notice to the server 200 (step D24), and returns the process to the step D10.

On the other hand, if the authentication is succeeded (the step D12: YES), the CPU 111 generates an encryption key through the encryption device 120, and transmits it to the mobile phone 300 (step D13). This encryption key is generated, temporarily and randomly, with respect to the process at the current time point.

If the encryption key is transmitted, the CPU 111 starts the generation of streaming data related to the designated content (step D14). At this time, the data of the content sequentially read from the recording medium 190 through the recording/reproducing apparatus 180 is extended by the compression/decompression device 150. Moreover, the streaming data is generated by the streaming device 130.

Along with the reproduction of the streaming data, the encryption process is performed by the encryption device 120 (step D15). As a result, the encrypted streaming data is transmitted to the mobile phone 300 (step D16). The CPU 111 sequentially transmits the encrypted streaming data to the mobile phone 300.

Incidentally, the encryption process on the PVR 100 is performed by the encryption device 120; however, such a process may be performed by the CPU 111 using an application program (i.e. one example of the “computer program” of the present invention).

If the transmission of the streaming data is started, the CPU 111 judges whether or not there is a reproduction error transmitted from the mobile phone 300 at the same time (step D17). If the reproduction error is received (the step D17: YES), namely, if some reproduction error occurs on the mobile phone 300, the reproduction process of the content is ended. In other words, the PVR 100 comes back in the waiting state.

On the other hand, if the reproduction error is not received, it is judged whether or not there is a request for an operation related to the reproduction (step D18). The request for the operation related to the reproduction indicates some operations other than stop, such as fast-forwarding, rewinding, and pause. If there is such a request (the step D18: YES), the CPU 111 performs the operation corresponding to the request (step D19), and proceeds the process to a step D20. On the other hand, if there is no such an operation request (the step D18: NO), the process is proceeded to the step D20.

In the step D20, it is judged whether the reproduction of the content is ended, or whether or not a stop instruction is transmitted from the user 40. As a result of the judgment, if there is no stop instruction from the user and the reproduction of the content is not ended (the step D20: NO), the process returns to the step D16, and the transmission of the encrypted streaming data is continued.

If there is a stop instruction from the user 40 or the reproduction of the content is ended (the step D20: YES), a reproduction end notice for announcing the end of the content reproduction is transmitted to the server 200 (step D21), and the content reproduction process is ended.

<Process of Mobile Phone 300>

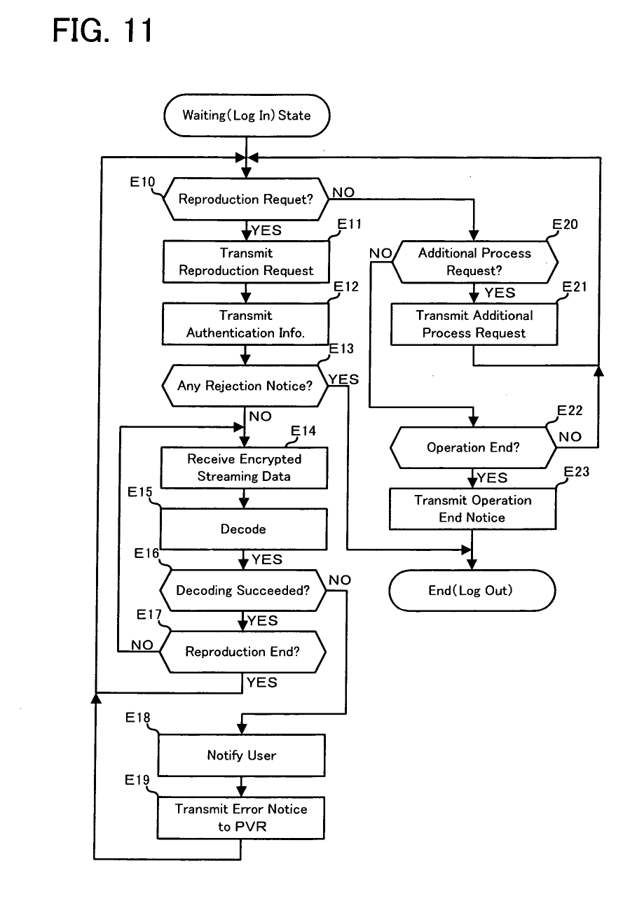

Next, with reference to FIG. 11, a process after log-in to the My HP on the mobile phone 300 will be discussed. FIG. 11 is a flowchart showing the process.

In FIG. 11, at first, the CPU 311 judges whether or not a request for reproducing the content is inputted through the input device 360 (step E10). Incidentally, the reproduction request is inputted through an operational procedure of opening a screen related to the content selection on the display device 350, or selecting the content from a list. In FIG. 11, the process which belongs to the procedure is omitted. If the reproduction request is inputted (the step E10: YES), the CPU 311 transmits the request for reproducing the content to the server 200 (step E11).

On the other hand, if there is no reproduction request (the step E10: NO), it is judged whether or not an additional process request is inputted (step E20). For example, if the additional process is requested, such as changing a list name, changing the wallpaper of the My HP, and deleting the content related to the recording medium 190 (the step E20: YES), the CPU 311 transmits the additional process request corresponding to the related additional process to the server 200 (step E21).

Moreover, if there is no additional process request (the step E20: NO), it is judged whether or not an operation end request is inputted (step E22). If there is no operation end request, the CPU 311 judges that there is no input, and returns the process to the step E10, and repeats the loop until some input is obtained from the user 40. On the other hand, if the user 40 inputs the operation end request to end the operation related to the My HP (the step E22: YES), an operation end notice is transmitted to the server 200 (step E23), and the log-out process is performed.

After the request for reproducing the content is transmitted (step E11), the CPU 311 transmits authentication information to the PVR 100, on the basis of an authentication information transmission request which is transmitted from the PVR 100 (step E12). If transmitting the authentication information, the CPU 311 judges whether or not there is a rejection notice from the PVR 100 through the server 200 (step E13). If the rejection notice is received (the step E13: YES), the request for reproducing the content is disregarded. The CPU 311 controls the display device 310 to display to announce that the rejection notice is received, to the user 40, and forces to perform the log-out process.

If there is no rejection notice (the step E13: NO), the CPU 311 receives the encryption key and the encrypted streaming data transmitted from the PVR 100 through the communication device 320 (step E14). At this time, the encryption key is temporarily stored into the RAM 313. The encrypted streaming data is supplied to the decoding device 340 through the signal processing device 330 and decoded (step E15). At this time, the encryption key stored in the RAM 313 is used for decoding.

Incidentally, the decoding process may be realized not by the decoding device 340 but by the CPU 311 executing a proper application program (i.e. another example of the “computer program” of the present invention).

The CPU 311 judges whether or not the decoding by the decoding device is succeeded (step E16). If the decoding is succeeded (the step E16: YES), moreover, it is judged whether or not the reproduction of the content is ended (step E17). If the reproduction is not ended (the step E17: NO), the CPU 311 returns the process to the step E14, and receives the encrypted streaming data to continue the decoding. Incidentally, the streaming data in which the decoding is succeeded is supplied to the display device 350, and is displayed by the display device 350 as the content designated by the user 40. If the reproduction is ended (the step E17: YES), the mobile phone 300 is again in the state of waiting an instruction from the user 40. Incidentally, in the judgment operation in the step E17, it is judged that the reproduction of the content is ended, by receiving a reproduction end notice transmitted form the server 200.

On the other hand, in decoding the content, if some error occurs (the step E16: NO), the user is notified of a decoding failure (step E18). This notice is given by the CPU 311 making the display device 350 display information which indicates that “the reproduction of the content is failed” or the like. Then, the CPU 311 transmits a reproduction error to the PVR 100 (step E19), returns the process to the step E10, and the sets the mobile phone 300 to be in an input waiting state.

As discussed above, according to the content remote watching system 10, the content can be selected on the My Homepage, so that the user 40 can get an extremely comfortable operational feeling without discomfort and a time loss caused by the communication with the PVR 100 all the time. Moreover, the PVR 100 is the possession of the user 40, and the content recorded on the recording medium 190 reflects the user's preference. Moreover, for example, by replacing a DVD or the like, as occasion demands, the selectable type of the contents increases remarkably, and it is easy to add a video filmed by the user with a video camera or the like as one of the contents. Therefore, it is possible to comfortably watch the content which matches the user's preference at a distant place.

Incidentally, in the embodiment, the content is streaming-reproduced; however, a data file related to the content recorded on the recording medium 190 may be transmitted to the mobile phone 300, with it compressed by the compression/decompression device 150. The transmitted data file may be stored into the RAM 313 or the like, decompressed if desired, and reproduced. In this case, even if the user 40 is somewhere it is impossible to communicate with the server 200 and the PVR 100 at the current time point, the user can watch the content anywhere by obtaining the content in advance from the PVR 100.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2004-262785 filed on Sep. 9, 2004 including the specification, claims, drawings and summary is incorporated herein by reference in its entirety.

What is claimed is:

1. A content remote watching system accommodated in a network, said system including:
(i) a recording/reproducing apparatus capable of recording and reproducing content;
(ii) a communication terminal owned by a user of said recording/reproducing apparatus and having portability; and
(iii) a server apparatus, said recording/reproducing apparatus comprising:
(i) a recording device for recording the content onto a recording medium; (ii) a first reproducing device for reproducing the recorded content; (iii) a content information generating device for generating content information which indicates recording content of the recording medium; and (iv) a first communicating device for transmitting the generated content information through the network to said server apparatus,
said server apparatus comprising:
(i) a visual information generating device for generating visual information which includes a list of the recorded content and which is associated with the user, on the basis of the transmitted content information;
and (ii) a second communicating device for transmitting the generated visual information through the network to said communication terminal,
said communication terminal comprising:
(i) a displaying device for displaying the transmitted visual information; (ii) an inputting device capable of inputting information for designating content to be reproduced from the list, on the displayed visual information; (iii) a first control information generating device for generating first control information, which is associated with the information inputted through the inputting device and which is to control said server apparatus; and (iv) a third communicating device for transmitting the generated first control information through the network to said server apparatus,
said server apparatus further comprising a second control information generating device for generating second control information to control said recording/reproducing apparatus in accordance with the transmitted first control information,
the second communicating device further transmitting the generated second control information through the network to said recording/reproducing apparatus,
the first reproducing device further generating information for reproduction to reproduce the designated content in accordance with the transmitted second control information,
the first communicating device further transmitting the generated information for reproduction through the network to said communication terminal,
said communication terminal further comprising a second reproducing device for reproducing the designated content on the basis of the transmitted information for reproduction,
the displaying device further displaying the content reproduced by the second reproducing device.

2. The content remote watching system according to claim 1, wherein said recording/reproducing apparatus further comprises the recording medium.

3. The content remote watching system according to claim 1, wherein said server apparatus further comprises a storing device for storing at least one of the transmitted content information and the generated visual information in association with the user.

4. The content remote watching system according to claim 1, wherein the visual information generating device generates the visual information so as to include at least one portion of the recorded content.

5. The content remote watching system according to claim 1, wherein
said server apparatus further comprises a first authenticating device for performing authentication to allow display of the visual information with respect to said communication terminal, and
the second communicating device transmits the visual information to said communication terminal with respect to which the display is allowed.

6. The content remote watching system according to claim 1, wherein
said recording/reproducing apparatus comprises a second authenticating device for performing authentication to allow reproduction of the designated content with respect to said communication terminal, and
the first communicating device transmits the information for reproduction, to said communication terminal with respect to which the reproduction is allowed.

7. The content remote watching system according to claim 1, wherein
at least one of said recording/reproducing apparatus and said server apparatus further comprises an encrypting device for encrypting the information for reproduction,
at least one of said communication terminal and said server apparatus further comprises a decoding device for decoding the encrypted information for reproduction,
the first communicating device transmits the encrypted information for reproduction, and
the second reproducing device reproduces the designated content on the basis of the decoded information for reproduction.

8. The content remote watching system according to claim 1, wherein
the visual information generating device further generates the visual information so as to include recording-content-changing-information for promoting performance of a recording content changing process related to a change in the recording content of the recording medium,
the inputting device can further input information for giving an instruction to perform the recording content changing process on the visual information, and
said recording/reproducing apparatus further comprises a recording-content-changing device for performing the recording content changing process in accordance with the transmitted second control information.

9. The content remote watching system according to claim 1, wherein
the visual information generating device further generates the visual information so as to include information for promoting a change in content of the visual information,
the inputting device further can input information for giving an instruction to change the visual information on the visual information, and
the visual information generating device changes the content of the visual information in accordance with the transmitted first control information.

10. The content remote watching system according to claim 1, wherein
said server apparatus further comprises a third control information generating device for generating third control information for giving an instruction to transmit the content information, with respect to said recording/reproducing apparatus,
the second communicating device further transmits the generated third control information in each predetermined timing, to said recording/reproducing apparatus,
the content information generating device generates the content information in accordance with the transmitted third control information, and
the first communicating device transmits the content information every time the content information is generated.

11. The content remote watching system according to claim 1, wherein
the content information generating device generates the content information if the recording content of the recording medium is changed, and
the first communicating device transmits the content information every time the content information is generated.

12. The content remote watching system according to claim 1, wherein the first reproducing device generates the information for reproduction, in accordance with a reproduction condition of the designated content in at least one of the second reproducing device and the displaying device.

13. The content remote watching system according to claim 1, wherein
said recording/reproducing apparatus further comprises a compressing device for compressing the designated content, and
the first reproducing device generates the information for reproduction related to the compressed content.

14. A server apparatus for content remote watching, capable of communicating with a recording/reproducing apparatus and a communication terminal through a network,
said recording/reproducing apparatus comprising:
(i) a recording device for recording content onto a recording medium;
(ii) an apparatus's side reproducing device for generating information for reproduction to reproduce designated content, in accordance with server-side control information, which is transmitted through the network, for giving an instruction to reproduce the designated content, out of contents recorded on the recording medium; (iii) a content information generating device for generating content information which indicates recording content of the recording medium; and (iv) an apparatus's side communicating device for transmitting the generated content information and the generated information for reproduction through the network to said server apparatus,
said communication terminal, owned by a user of said recording/reproducing apparatus and having portability, comprising:
(i) a displaying device for displaying visual information which is transmitted through the network, which includes a list of the recorded content, and which is associated with the user; (ii) an inputting device capable of inputting information for designating content to be reproduced from the list included in the displayed visual information, as the designated content; (iii) a terminal-side control information generating device for generating terminal-side control information, which is associated with the information inputted through the inputting device; (iv) a terminal-side communicating device for transmitting the generated terminal-side control information through the network; and (v) a terminal-side reproducing device for reproducing the designated content on the basis of the transmitted information for reproduction,
said server apparatus comprising:
a visual information generating device for generating the visual information on the basis of the transmitted content information;
a server-side communicating device for transmitting the generated visual information through the network to said communication terminal; and
a server-side control information generating device for generating the server-side control information in accordance with the transmitted terminal-side control information,
the server-side communicating device transmitting the generated server-side control information through the network to said recording/reproducing apparatus.

15. A recording/reproducing apparatus for content remote watching, capable of communicating with a server apparatus and a communication terminal through a network,
said server apparatus comprising:
(i) a visual information generating device for generating visual information which includes a list of content recorded on a recording medium, on the basis of content information which is transmitted through the network and which indicates recording content of the recording medium; (ii) a server-side communicating device for transmitting server-side control information for giving an instruction to reproduce the generated visual information and designated content, through the network; and (iii) a server-side control information generating device for generating the server-side control information in accordance with terminal-side control information, which is transmitted through the network, for requesting reproduction of the designated content,
said communication terminal having portability, comprising:
(i) a displaying device for displaying the transmitted visual information; (ii) an inputting device capable of inputting information for designating content to be reproduced from the list included in the displayed visual information, as the designated content; (iii) a terminal-side control information generating device for generating the terminal-side control information; (iv) a terminal-side communicating device for transmitting the generated terminal-side control information through the network to said server apparatus; and (v) a terminal-side reproducing device for reproducing the designated content on the basis of information for reproduction transmitted through the network,
said recording/reproducing apparatus comprising:
a recording device for recording the content onto the recording medium;
an apparatus's side reproducing device for reproducing the recorded content;
a content information generating device for generating the content information; and
an apparatus's side communicating device for transmitting the generated content information through the network to said server apparatus,
the apparatus's side reproducing device generating the information for reproduction to reproduce the designated content, in accordance with the transmitted server-side control information,
the apparatus's side communicating device further transmitting the generated information for reproduction through the network, to said communication terminal.

16. A content remote watching method performed in a content remote watching system accommodated in a network, said system including: (i) a recording/reproducing apparatus capable of recording and reproducing content; (ii) a communication terminal owned by a user of said recording/reproducing apparatus and having portability; and (iii) a server apparatus,
said method comprising:
in said recording/reproducing apparatus,
(i) a recording process of recording the content onto a recording medium; (ii) a first reproducing process of reproducing the recorded content; (iii) a content information generating process of generating content information which indicates recording content of the recording medium; and
(iv) a first transmitting process of transmitting the generated content information through the network to said server apparatus,
in said server apparatus,
(i) a visual information generating process of generating visual information which includes a list of the recorded content and which is associated with the user, on the basis of the transmitted content information;
and (ii) a second transmitting process of transmitting the generated visual information through the network to said communication terminal,
in said communication terminal,
(i) a displaying process of displaying the transmitted visual information; (ii) an inputting process of inputting information for designating content to be reproduced from the list, on the displayed visual information; (iii) a first control information generating process of generating first control information, which is associated with the information inputted in the inputting process and which is to control said server apparatus; and (iv) a third transmitting process of transmitting the generated first control information through the network to said server apparatus,
in said server apparatus, said method further comprising a second control information generating process of generating second control information to control said recording/reproducing apparatus in accordance with the transmitted first control information,
in said server apparatus, said method further comprising a fourth transmitting process of transmitting the generated second control information through the network to said recording/reproducing apparatus,
the first reproducing process further generating information for reproduction to reproduce the designated content in accordance with the transmitted second control information,
in said recording/reproducing apparatus, said method further comprising a fifth transmitting process of transmitting the generated information for reproduction through the network to said communication terminal,
in said communication terminal, said method further comprising a second reproducing process of reproducing the designated content on the basis of the transmitted information for reproduction,
the displaying processing further displaying the content reproduced by the second reproducing process.

17. The content remote watching method according to claim 16, wherein
said method further comprises:
an encrypting process of encrypting the information for reproduction, in at least one of said recording/reproducing apparatus and said server apparatus; and
a decoding process of decoding the encrypted information for reproduction, in at least one of said communication terminal and said server apparatus,
the fifth transmitting process transmits the encrypted information for reproduction, and
the second reproducing process reproduces the designated content on the basis of the decoded information for reproduction.

18. The content remote watching method according to claim 16, further comprising a charging process of charging to the user in accordance with a usage situation of said server apparatus.

19. A computer program product in a computer-readable medium for tangibly embodying a program of instructions executable by a computer system to make the computer system function as at least one portion of a server apparatus in a content remote watching system accommodated in a network,
said system including:
(i) a recording/reproducing apparatus capable of recording and reproducing content;
(ii) a communication terminal owned by a user of said recording/reproducing apparatus and having portability; and
(iii) said server apparatus,
said recording/reproducing apparatus comprising:
(i) a recording device for recording the content onto a recording medium; (ii) a first reproducing device for reproducing the recorded content; (iii) a content information generating device for generating content information which indicates recording content of the recording medium; and (iv) a first communicating device for transmitting the generated content information through the network to said server apparatus,
said server apparatus comprising:
(i) a visual information generating device for generating visual information which includes a list of the recorded content and which is associated with the user, on the basis of the transmitted content information;
and (ii) a second communicating device for transmitting the generated visual information through the network to said communication terminal,
said communication terminal comprising:
(i) a displaying device for displaying the transmitted visual information; (ii) an inputting device capable of inputting information for designating content to be reproduced from the list, on the displayed visual information; (iii) a first control information generating device for generating first control information, which is associated with the information inputted through the inputting device and which is to control said server apparatus; and (iv) a third communicating device for transmitting the generated first control information through the network to said server apparatus,
said server apparatus further comprising a second control information generating device for generating second control information to control said recording/reproducing apparatus in accordance with the transmitted first control information,
the second communicating device further transmitting the generated second control information through the network to said recording/reproducing apparatus,
the first reproducing device further generating information for reproduction to reproduce the designated content in accordance with the transmitted second control information,
the first communicating device further transmitting the generated information for reproduction through the network to said communication terminal,
said communication terminal further comprising a second reproducing device for reproducing the designated content on the basis of the transmitted information for reproduction,
the displaying device further displaying the content reproduced by the second reproducing device.

20. A computer program product in a computer-readable medium for tangibly embodying a program of instructions executable by a computer system to make the computer system function as at least one portion of a communication terminal in a content remote watching system accommodated in a network,
said system including:
(i) a recording/reproducing apparatus capable of recording and reproducing content;
(ii) said communication terminal owned by a user of said recording/reproducing apparatus and having portability; and
(iii) a server apparatus,
said recording/reproducing apparatus comprising:
(i) a recording device for recording the content onto a recording medium; (ii) a first reproducing device for reproducing the recorded content; (iii) a content information generating device for generating content information which indicates recording content of the recording medium; and (iv) a first communicating device for transmitting the generated content information through the network to said server apparatus,
said server apparatus comprising:
(i) a visual information generating device for generating visual information which includes a list of the recorded content and which is associated with the user, on the basis of the transmitted content information; and (ii) a second communicating device for transmitting the generated visual information through the network to said communication terminal,
said communication terminal comprising:
(i) a displaying device for displaying the transmitted visual information; (ii) an inputting device capable of inputting information for designating content to be reproduced from the list, on the displayed visual information; (iii) a first control information generating device for generating first control information, which is associated with the information inputted through the inputting device and which is to control said server apparatus; and (iv) a third communicating device for transmitting the generated first control information through the network to said server apparatus,
said server apparatus further comprising a second control information generating device for generating second control information to control said recording/reproducing apparatus in accordance with the transmitted first control information,
the second communicating device further transmitting the generated second control information through the network to said recording/reproducing apparatus,
the first reproducing device further generating information for reproduction to reproduce the designated content in accordance with the transmitted second control information,
the first communicating device further transmitting the generated information for reproduction through the network to said communication terminal,
said communication terminal further comprising a second reproducing device for reproducing the designated content on the basis of the transmitted information for reproduction,
the displaying device further displaying the content reproduced by the second reproducing device.

21. A computer program product in a computer-readable medium for tangibly embodying a program of instructions executable by a computer system to make the computer system function as at least one portion of a recording/reproducing apparatus in a content remote watching system accommodated in a network,
said system including:
(i) said recording/reproducing apparatus capable of recording and reproducing content;
(ii) a communication terminal owned by a user of said recording/reproducing apparatus and having portability; and
(iii) a server apparatus,
said recording/reproducing apparatus comprising:
(i) a recording device for recording the content onto a recording medium; (ii) a first reproducing device for reproducing the recorded content; (iii) a content information generating device for generating content information which indicates recording content of the recording medium; and (iv) a first communicating device for transmitting the generated content information through the network to said server apparatus,
said server apparatus comprising:
(i) a visual information generating device for generating visual information which includes a list of the recorded content and which is associated with the user, on the basis of the transmitted content information; and (ii) a second communicating device for transmitting the generated visual information through the network to said communication terminal,
said communication terminal comprising:
(i) a displaying device for displaying the transmitted visual information; (ii) an inputting device capable of inputting information for designating content to be reproduced from the list, on the displayed visual information; (iii) a first control information generating device for generating first control information, which is associated with the information inputted through the inputting device and which is to control said server apparatus; and (iv) a third communicating device for transmitting the generated first control information through the network to said server apparatus,
said server apparatus further comprising a second control information generating device for generating second control information to control said recording/reproducing apparatus in accordance with the transmitted first control information,
the second communicating device further transmitting the generated second control information through the network to said recording/reproducing apparatus,
the first reproducing device further generating information for reproduction to reproduce the designated content in accordance with the transmitted second control information,
the first communicating device further transmitting the generated information for reproduction through the network to said communication terminal,
said communication terminal further comprising a second reproducing device for reproducing the designated content on the basis of the transmitted information for reproduction,
the displaying device further displaying the content reproduced by the second reproducing device.
